(19) United States
(12) Patent Application Publication
(10) Pub. No.: US 2024/0037491 A1
(43) Pub. Date: Feb. 1, 2024

(54) Systems and Methods for Facilitating Delivery to an Unspecified Location

(71) Applicant: Rocky Mountain Robotech LLC, Superior, CO (US)

(72) Inventors: Chunbiao GU, Superior, CO (US); Shichao ZHANG, Superior, CO (US); Yang YANG, Changchun (CN)

(21) Appl. No.: 18/226,565

(22) Filed: Jul. 26, 2023

Related U.S. Application Data
(60) Provisional application No. 63/392,418, filed on Jul. 26, 2022.

(51) Int. Cl. G06Q 10/0833; G05D 1/02; G05D 1/10; G05D 1/12

(52) U.S. Cl. CPC G06Q 10/0833; G05D 1/0212; G05D 1/0208; G05D 1/101; G05D 1/12; G06K 7/10297

(57) ABSTRACT

Systems and methods for delivery of items to an unspecified location, such as a moving location, are described. The systems and methods utilize a location-finding device to identify a location of a location-disclosing device associated with ordered items, and notify the location-disclosing device when an automated delivery device is within a predetermined proximity in order to arrange a specific location for delivery of the ordered items.

### CROSS-REFERENCE TO RELATED APPLICATIONS

This application claims the benefit of and priority to U.S. Provisional Patent Application No. 63/392,418, filed Jul. 26, 2022, which is hereby incorporated by reference in its entirety.

### STATEMENT REGARDING FEDERALLY SPONSORED RESEARCH

None.

### BACKGROUND

Delivery services are pervasive in our daily lives, and they continue to increase in importance because we are accustomed to shopping online and having purchased items—from cars to take-out food and groceries—brought to our homes or workplaces. While delivery is more convenient and efficient than having every person visit every store, there are still times when a person is required to wait at the delivery location to receive a shipment or when shipments left at an unoccupied location are stolen. Therefore, current delivery methods could be improved.

### SUMMARY

The present systems and methods facilitate delivery of goods to an unspecified location, which may be spatially and/or temporally varying. Delivery of the goods is accomplished by associating an order of goods with a location-disclosing device that can be tracked and notified when an automated delivery device is nearby. After notification, a specific location may be set for the delivery to take place. Such systems and methods would improve the convenience and efficiency of everything from automated food service to “last mile” delivery between a distribution facility and the customer by allowing a location-disclosing device, such as a smart phone, to be associated with the order. A customer having a location-disclosing device with them may then enjoy the convenience of moving freely until an automated delivery device, such as a food service robot or a package-containing drone, is nearby. Further, overall efficiency would be improved by achieving fewer missed deliveries and stolen packages.

In an aspect, a system for delivery of items to an unspecified location comprises a repository that stores associations of ordered items and their corresponding location-disclosing devices, a location-finding device configured to identify a location of one of the location-disclosing devices, and a control module in communication with the repository and the location-finding device. The control module is configured to guide an automated delivery device that brings the ordered item(s) into proximity with the one location-disclosing device and, when the automated delivery device is within a predetermined proximity to the one location-disclosing device, to provide instructions to the one location-disclosing device regarding a specific location at which the delivery will be made.

In an embodiment, the repository is cloud-based. In an embodiment, one or more of the repository and the location-finding device are disposed within the control module. In an embodiment, one or more of the repository, the location-finding device, and the control module are disposed within the automated delivery device.

In an embodiment, the associations within the repository further include the locations of the location-disclosing devices with the location-disclosing devices and/or ordered item(s).

In an embodiment, the location-disclosing devices are pagers, smart phones, tablets, smart watches, and/or AirTags®. For example, each of the location-disclosing devices may independently utilize a technology selected from the group consisting of radio frequency identification (RFID), Bluetooth®, global positioning system (GPS) coordinates, and near-field infrared.

In an embodiment, the automated delivery device is a terrestrial self-driving robotic vehicle (SDRV), a flying drone, an unmanned boat, or an unmanned submarine.

In an embodiment, the automated delivery device comprises a delivery verification device. For example, the delivery verification device may be a signature pad, a keypad, a camera, and/or a magnetic card reader.

In an embodiment, the automated delivery device comprises an RFID activation/deactivation pad.

In an aspect, a method for delivery of items to an unspecified location comprises associating an ordered item(s) with a location-disclosing device, identifying a location of the location-disclosing device with a location-finding device; using an automated delivery device to bring the ordered item(s) into proximity with the location-disclosing device, and, when the automated delivery device is within a predetermined proximity to the location-disclosing device, providing instructions to the location-disclosing device regarding a specific location at which the delivery will be made. For example, the specific location at which the delivery will be made may be a restaurant table, a location within a building, a location on a side of a road, etc.

In an embodiment, the method further comprises stopping the location-finding device from tracking the location-disclosing device after the delivery is complete.

In an embodiment, the automated delivery device receives the location-disclosing device in exchange for the ordered item(s).

In an embodiment, the method further comprises obtaining verification of the delivery. For example, obtaining verification may include obtaining a signature, obtaining a verification code, taking a picture of the recipient of the ordered item(s), obtaining electronic payment, and/or sending a pin code to the recipient for use in opening the automated delivery device.

### BRIEF DESCRIPTION OF THE DRAWINGS

Illustrative embodiments of the present invention are described in detail below with reference to the attached drawings, wherein:

FIG. 1 is a schematic showing exemplary associations made by an association module of a system for delivery of items to an unspecified location, according to an embodiment;

FIG. 2 is a schematic showing exemplary components of a system for delivery of items to an unspecified location, according to an embodiment;

FIG. 3 is a schematic showing exemplary components of a system for delivery of items to an unspecified location, according to an embodiment;

FIG. 4 is a schematic showing exemplary components of a system for delivery of items to an unspecified location, according to an embodiment;

FIG. 5 is a flowchart showing steps in a method for delivery of items to an unspecified location, according to an embodiment; and

FIG. 6 is a flowchart showing steps in a method for delivery of items to an unspecified location, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, an “automated delivery device” is a vehicle capable of navigating routes through the use of onboard sensors that detect exogenous navigation markers or other objects within the surroundings. For example, an automated delivery device may contain one or more infrared, near field, or radio sensors, cameras, or other detection devices that capture data from navigation markers or other surroundings. The data or images are then analyzed by a local or remote computer processor to determine what action the automated delivery device should perform (e.g., stop, turn, reverse, etc.), and the processor sends instructions for carrying out the action to motive components of the automated delivery device. The motive components then perform the action—all without human supervision.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third object).

As used herein, the terms “processor” and “computer” and related terms, e.g., “processing device”, “computing device”, and “controller” are not limited to just those integrated circuits referred to in the art as a computer, but broadly refer to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

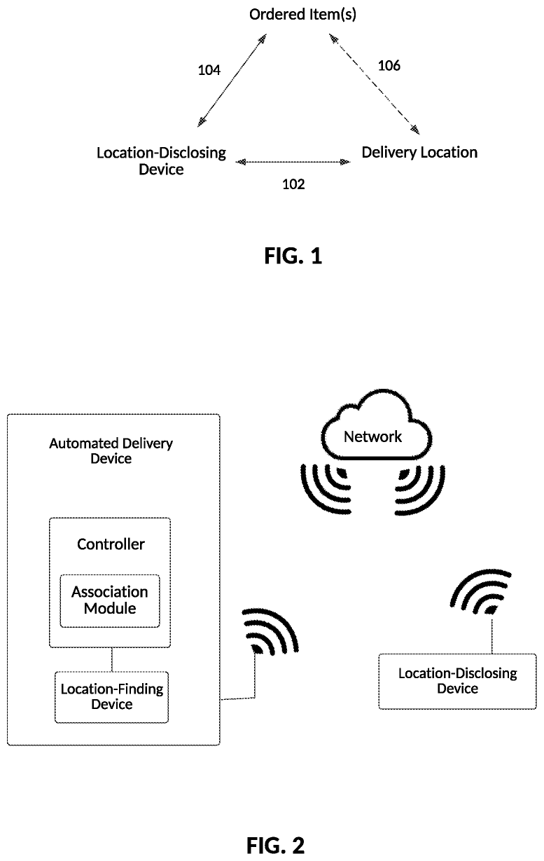

Exemplary systems and methods relating to delivery of items to an unspecified location can be seen in FIGS. 1-6. Multiple items within a figure may not be labeled for clarity.

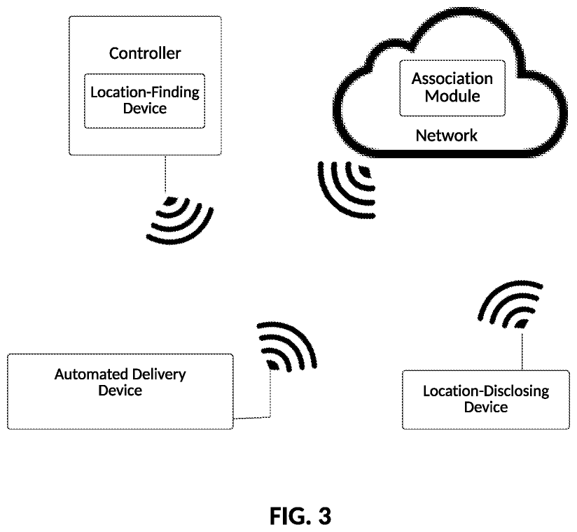

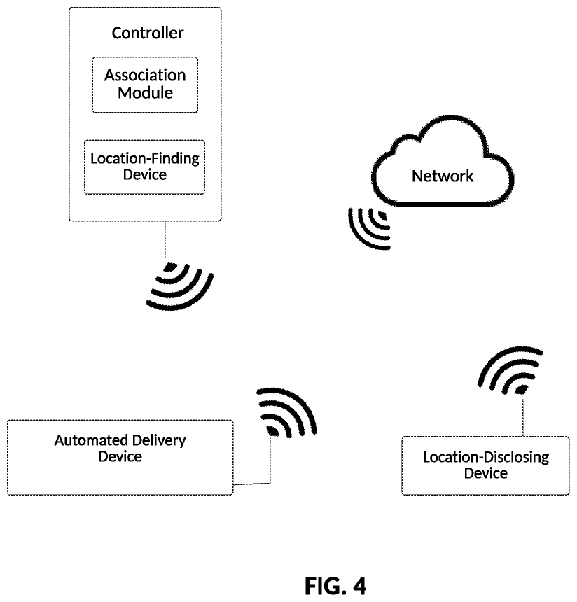

FIG. 1 is a schematic showing exemplary associations made by an association module/repository of a system for delivery of items to an unspecified location, according to an embodiment. Association 102 exists between a location-disclosing device (LDD) and a delivery location because the LDD is intended to be with the customer (e.g., on the customer's person) at the time the item(s) are delivered. Association 104 is created when the item(s) are ordered. During the ordering process, a person or computer will either assign an LDD to a customer (e.g., give the customer a pager electronically associated with the order) or query the customer to associate his or her own device. Association 106 is formed only when a final specific delivery location is set. For example, a restaurant customer may set the location by selecting a table and placing the pager on an RFID reader associated with the table. In another example, a controller may set the final delivery location when an automated delivery device approaches within a predefined proximity of the LDD. A message, location pin or other signal may be sent to the LDD. For example, the predefined location for a drone delivery may be divided into a coarse proximity of 50 feet with the corresponding message or signal to the LDD being “go outside”, a middle range proximity of 20 feet with a corresponding message to the LDD being “approaching”, and a final proximity being within five feet of the LDD and the corresponding message or signal to the LDD may be “hold steady” or “do not move”. As described further herein, associations 102, 104 and/or 106 may be stored in a computer memory, such as within a lookup table. The memory may be local, such as within hardware of an ADD (FIG. 2), and/or remote and accessible via cloud storage (FIG. 3 and FIG. 4).

FIG. 2 is a schematic showing exemplary components of a system for delivery of items to an unspecified location, according to an embodiment. The system includes an ADD housing a controller/control module having an association module containing the types of associations discussed with respect to FIG. 1. The ADD also includes a location-finding device (LFD) communicatively coupled with an LDD. Communication between the LFD and LDD may occur directly (e.g., via radio signals sent and received via antennas on each device) or indirectly (e.g., through a communication network). FIG. 3 shows an alternate arrangement of the exemplary components of a system for delivery of items to an unspecified location, according to an embodiment. In FIG. 3, the association module is remotely stored on a cloud network. In addition, a remote controller comprises the LFD, which is in communication with the LDD. The controller provides instructions to the ADD for navigation and coordinates the rendezvous and exchange of goods between the ADD and LDD. In yet another embodiment, FIG. 4 shows exemplary components of a system for delivery of items to an unspecified location where a remote controller coordinates all functions (e.g., association, location finding, navigation, etc.) between the ADD and the LDD with communication occurring over a local network or non-local network. In a further embodiment, the remote controller of FIG. 4 and all of its functionality may be housed in the cloud.

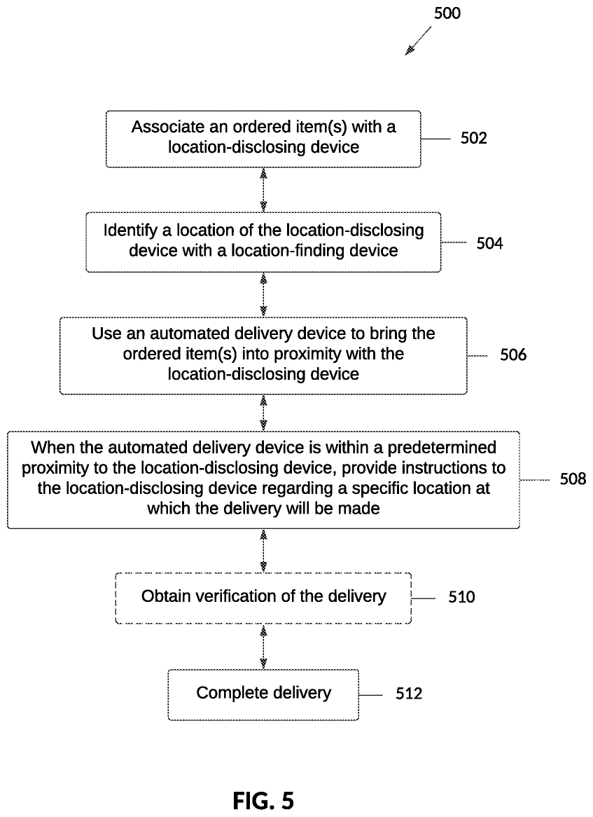

FIG. 5 is a flowchart 500 showing steps in a method for delivery of items to an unspecified location, according to an embodiment. The method begins with step 502 where an ordered item is electronically associated with a location-disclosing device, for example, in a lookup table. In step 504, a location of an LDD is identified by an LFD, and ADD is used to bring the ordered item into proximity with the LDD, in step 506. When the ADD is within a predetermined proximity to the LDD, a controller (either remote or within the ADD) provides instructions to the LDD regarding a specific location at which the delivery will be made (step 508). In an embodiment, the LDD may veto the specific location, may specify a new location, and/or may refuse to accept the delivery. In another embodiment, instead of the controller assigning a specific location at which the delivery will be made, the controller may query the LDD to select the location at which the delivery will be made, and the controller may veto the specific location, suggest a new location, and/or refuse to deliver the ordered item(s) if a mutually agreeable location cannot be identified within a specific timeframe. In optional step 510, the delivery is verified. For example, the delivery may be verified by one or more of a signature, voice authentication, or a picture of the recipient, a credit card or other electronic payment, or by sending a pin code to the recipient and requiring use of the pin code to access items from the ADD. In step 512, the delivery is completed, so long as a mutually agreeable location is identified and the LDD has not refused delivery.

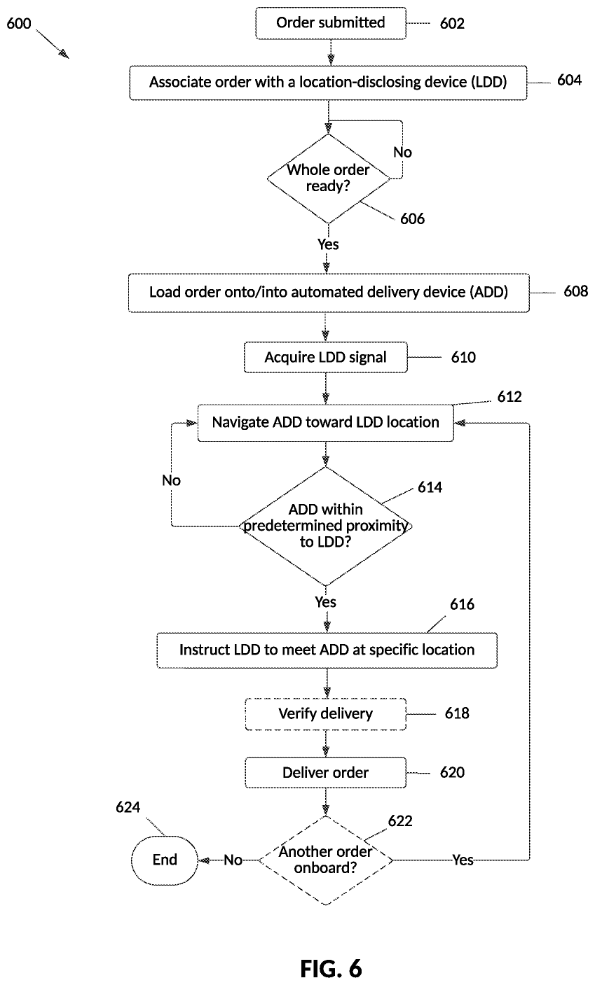

FIG. 6 is a flowchart 600 showing steps in a method for delivery of items to an unspecified location, according to an embodiment. In step 602, an order is submitted into a computerized ordering system. In step 604, the order is associated with an LDD. Step 606 is a query asking whether the whole order is ready. If the answer is no, the method circles back to step 606 and waits until the answer is yes. In step 608, instructions are sent to load the order onto or into an ADD, and an LDD signal corresponding to the order is acquired by an LFD (step 610). A controller then navigates the ADD toward the LDD location (step 612), while constantly querying whether the ADD is within a predetermined proximity to the LDD (step 614). If the answer is no, the navigation of step 612 continues. When the ADD is within a predetermined proximity to the LDD, the LDD is instructed to meet the ADD at a specific location (step 616). Optionally, verification of the recipient is obtained in step 618, and the order is delivered in step 620. Step 622 is a query asking whether the is another order onboard the ADD. If the answer is yes, navigation toward a new LDD location commences with step 612. If the answer is no, the method ends (step 624) and the ADD may return to its homebase.

More specific non-limiting information relating to particular usage scenarios is provided below.

### Example 1: Restaurant Service

A customer purchasing prepared food in a dining establishment may have their order entered into a computerized ordering system by an employee or may enter their own order (e.g., at a kiosk). A paging device (LDD) is then associated with the order in the computer system, e.g., via activation on an RFID pad, and given to the customer, who is free to roam. When the order is ready, a notice (e.g., vibration or text message) is sent to the paging device and either the customer moves to a desired location to receive the order, such as a vacant table, and forms an association between the paging device and the location by placing the paging device on an RFID pad disposed on or under the table, or the ADD will navigate to the paging device's location. The second option (ADD navigates to paging device's location) may be desirable, for example, when the ADD delivers drinks or small appetizers. If the ADD arrives at the paging device's/customer's location and the customer does not wish to take possession of the food item(s) there, he or she may merely move to the desired location and the ADD will follow.

In some embodiments, such as where the system is configured to require a paging device (LDD) be received by the ADD (e.g., food delivery robot) in exchange for the ordered items, the ADD may remain at the delivery location and present an audio and/or visual message instructing the customer to place the paging device on a tray of the ADD. Once the paging device is detected as being returned to the ADD, such as by a sensor of the ADD, the ADD will disassociate the paging device and the ordered items within the repository. Because the ordered item(s) and table location remain associated, future transactions such as additional food service and/or payment will not be impacted by disassociation of the paging device from the triad shown in FIG. 1. In some embodiments, an RFID pad may form part of the ADD allowing it to accomplish the disassociation. An ADD possessing a deactivated paging device will return it to a designated location, such as an ordering location (kiosk), where it can be associated with a new order.

### Example 2: Drone-to-Phone Delivery

A customer may purchase an item by computer, tablet, smart phone or smart watch, and associate the device used for the purchase or another of their devices with the purchase. So long as location services are enabled on the designated device, it can serve as a personal LDD for the order. Thus, delivery of the item will be targeted directly to the customer, instead of to their home or office. This type of delivery may be useful where the customer needs the item quickly, but also needs to carry on their daily activities. For example, if the item can be quickly delivered from a nearby fulfillment center to a soccer field by drone, the customer may be less pressed for time than if he or she needed to stop at home or at a store for the item.

### Statements Regarding Incorporation by Reference and Variations

All references cited throughout this application, for example patent documents including issued or granted patents or equivalents; patent application publications; and non-patent literature documents or other source material; are hereby incorporated by reference herein in their entireties, as though individually incorporated by reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a processor” includes a plurality of such processors and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

What is claimed is:

1. A system for delivery of items to an unspecified location comprising:
a repository that stores associations of ordered items and their corresponding location-disclosing devices;
a location-finding device configured to identify a location of one of the location-disclosing devices; and
a control module in communication with the repository and the location-finding device, the control module configured:
to guide an automated delivery device that brings the ordered item(s) into proximity with the one location-disclosing device; and
when the automated delivery device is within a predetermined proximity to the one location-disclosing device, to provide instructions to the one location-disclosing device regarding a specific location at which the delivery will be made.

2. The system of claim 1, wherein the repository is cloud-based.

3. The system of claim 1, wherein one or more of the repository and the location-finding device are disposed within the control module.

4. The system of claim 1, wherein one or more of the repository, the location-finding device, and the control module are disposed within the automated delivery device.

5. The system of claim 1, wherein the associations within the repository further include the locations of the location-disclosing devices.

6. The system of claim 1, wherein the location-disclosing devices are pagers, smart phones, tablets, smart watches, and/or AirTags®.

7. The system of claim 1, wherein each of the location-disclosing devices utilizes a technology selected from the group consisting of radio frequency identification (RFID), Bluetooth®, global positioning system (GPS) coordinates, and near-field infrared.

8. The system of claim 1, wherein the automated delivery device is a terrestrial self-driving robotic vehicle (SDRV), a flying drone, an unmanned boat, or an unmanned submarine.

9. The system of claim 1, wherein the automated delivery device comprises a delivery verification device.

10. The system of claim 9, wherein the delivery verification device is a signature pad, a keypad, a camera, and/or a magnetic strip.

11. The system of claim 1, wherein the automated delivery device comprises an RFID activation/deactivation pad.

12. A method for delivery of items to an unspecified location comprising:
associating an ordered item(s) with a location-disclosing device;
identifying a location of the location-disclosing device with a location-finding device;
using an automated delivery device to bring the ordered item(s) into proximity with the location-disclosing device; and
when the automated delivery device is within a predetermined proximity to the location-disclosing device, providing instructions to the location-disclosing device regarding a specific location at which the delivery will be made.

13. The method of claim 12, wherein the location-disclosing device is a pager, a smart phone, a tablet, a smart watch, or an AirTag®.

14. The method of claim 12, wherein the location-disclosing device utilizes a technology selected from the group consisting of radio frequency identification (RFID), Bluetooth®, global positioning system (GPS) coordinates, and near-field infrared.

15. The method of claim 12, wherein the automated delivery device is a terrestrial self-driving robotic vehicle (SDRV), a flying drone, an unmanned boat, or an unmanned submarine.

16. The method of claim 12, further comprising stopping the location-finding device from tracking the location-disclosing device after the delivery is complete.

17. The method of claim 12, wherein the automated delivery device receives the location-disclosing device in exchange for the ordered item(s).

18. The method of claim 17, wherein the automated delivery device comprises an RFID activation/deactivation pad.

19. The method of claim 12, further comprising obtaining verification of the delivery.

20. The method of claim 19, wherein obtaining verification comprises obtaining a signature, obtaining a verification code, taking a picture of the recipient of the ordered item(s), obtaining electronic payment, and/or sending a pin code to the recipient for use in accessing the automated delivery device.
